(19) United States
(12) Patent Application Publication
(10) Pub. No.: US 2004/0118302 A1
(43) Pub. Date: Jun. 24, 2004

(54) Apparatus comprising a vacuum filler and clip module

(76) Inventor: Gerhard Muller, Schemmerhofen (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/713,320

(22) Filed: Nov. 14, 2003

(30) Foreign Application Priority Data
Nov. 22, 2002 (EP) 02026096.4

(51) Int. Cl. A23B 4/00

(52) U.S. Cl. 99/472

(57) ABSTRACT

The invention relates to an apparatus comprising a vacuum filler (3) for stuffing a casing (4) of any kind with a pasty substance and a clip module (1) for applying a clip (2) to a stuffed casing (4). The apparatus is characterized in that the clip module (1) is adapted to be driven by the vacuum filler (3). Furthermore, the invention relates to a method of applying to a casing (4) of any kind a clip (2) by means of a clip module (1), said method comprising the steps of: -stuffing the casing (4) with a pasty substance by means of a vacuum filler (3), -separating the portions, -applying a clip (2) by means of a clip module (1). The method is characterized in that the clip module (1) is driven by the vacuum filler (3).

The present invention relates to an apparatus comprising a vacuum filler and a clip unit. The vacuum filler serves to stuff a casing with a pasty substance, such as sausage meat. The stuffing process can be followed by twisting off, tying off, constricting or the like, i.e. a separation by means of which a location is formed at which no or only a small amount of pasty substance is present in the casing so that a clip can subsequently be applied to this point. Such clips are made e.g. of metal or of plastic material. The clip closes the casing so that the pasty substance stuffed into said casing cannot escape. This is done e.g. in sausage production processes.

Clip machines known from practical experience are provided with an electric or a pneumatic drive of their own, which serves, among other purposes, the purpose of actuating the mechanical components of the clip machine. The control of the clip machine is effected e.g. by the vacuum filler which determines the moment at which a clip is to be set. This is normally done when one portion of pasty stuffing material has been provided in the casing.

Such automatic clip machines proved to be very expensive and their capacity (portions/minute)is often limited.

It is therefore the object of the present invention to provide an apparatus which comprises a vacuum filler and a clip unit, as well as a method of applying a clip, which are less expensive and which permit a larger number of clips to be set per unit time.

This object is achieved by an apparatus according to claim 1 and by a method according to claim 12. Preferred embodiments are disclosed in the respective subclaims.

In said apparatus, the vacuum filler and the clip module are coupled to one another so that a drive, such as a motor, e.g. a servomotor, in the vacuum filler can be used for driving the clip module. This offers the possibility of dispensing with a separate pneumatic or electric drive of the clip module. Such additional drives are, however, not excluded.

Furthermore, a servomotor allows, in comparison with other pneumatic and electric drives, higher speeds and a higher precision in the sequence of movements when the clip is being set, so that higher processing speeds are achieved.

The motor of the vacuum filler has a rotatable axle or is coupled to a rotatable part by means of which the clip module can be driven. The drive can be effected e.g. via a shaft which is provided between the vacuum filler and the clip module.

The clip module comprises preferably a displacer by means of which the locations can be formed at which no or only a small amount of pasty substance is present in the casing so that the clips can be applied there. This displacer separates the various portions of pasty substance in the casing from one another in this way. The separation of these portions can be carried out by constricting the casing with rings, U- or V-shaped jaws, clamps or bows, rolls, cylinders etc..

The clip module is optionally provided with an additional separator. Hence, the sausage strands can be separated such that individual portions or chains of portions comprising an arbitrary number of portions are formed.

According to a preferred embodiment, the drive of the clip module can be provided by a connection for a twist-off unit, said connection being provided at the vacuum filler.

Preferably, the vacuum filler is provided with a control unit by means of which the stuffing, the portioning and the setting of clips can be controlled. In order to achieve this, the control unit controls, among other components, the motors, e.g. of a vane pump conveyor unit by means of which the pasty substance is conveyed to a stuffing tube, and e.g. a servomotor for driving the clip module. Due to the use of the servo-drive of the clip module, the steps of stuffing, portioning and clip setting can overlap so that, in total, a higher production speed will be achieved.

The apparatus may also comprise a suspension unit, which is, in accordance with an advantageous embodiment, an automatic suspension unit.

Advantageous embodiments of the clip module and of the vacuum filler as well as of the method for applying a clip are described with reference to the figures enclosed, in which:

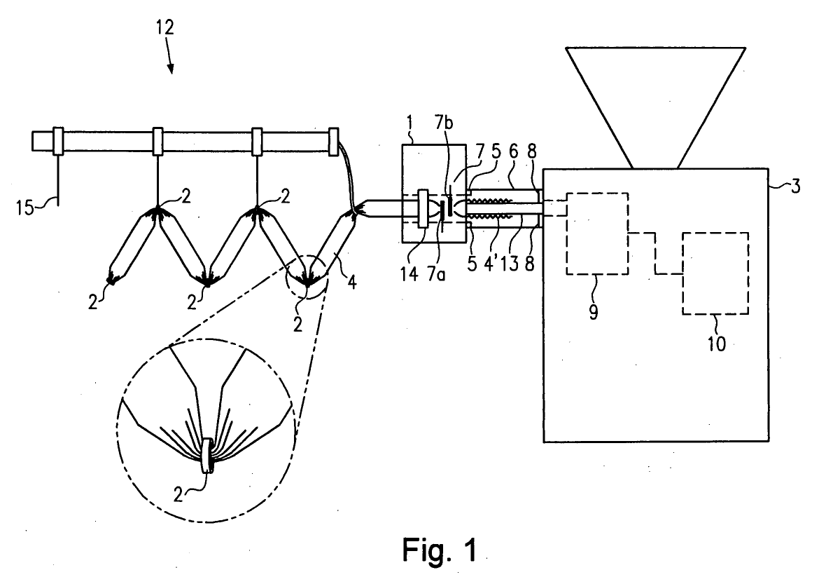

FIG. 1 shows a schematic representation of a first embodiment of the present invention, and

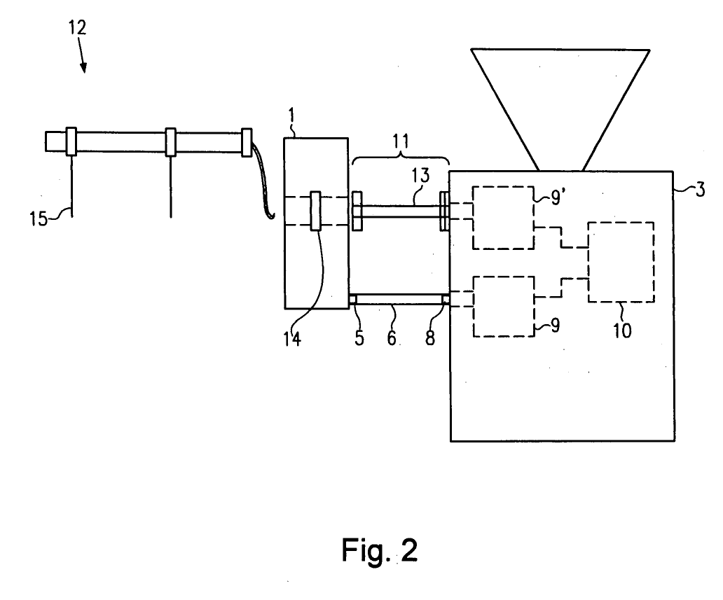

FIG. 2 shows a schematic representation of a second embodiment of the present invention.

FIG. 1 shows an apparatus comprising a vacuum filler 3 and a clip module 1, said vacuum filler being adapted to be filled with a pasty substance from above through the hopper. The vacuum filler 3 comprises a stuffing tube 13 provided for stuffing a casing. Adjacent the stuffing tube a clip module is arranged, which comprises a displacer 7 and a clip setting means 14. The displacer 7 comprises two elements 7a and 7b which are movable relative to one another and which are capable of confining a casing between them. The clip setting means 14 is able to set the clips 2. Said clip setting means 14 can be arranged adjacent the displacer 7, or directly at, or between said displacer 7, so that the clips 2 can be set in the area of the displacer 7. The clip setting means 14 can be implemented such that two neighbouring clips 2 can be set simultaneously.

A separator 16 is provided at, or between, or downstream of the clip setting means 14. It serves to separate individual portions or a plurality of portions from one another. If the displacer 7 provided comprises two sets of e.g. displacer jaws, which permit the formation of a broad constriction in the casing 4, and if the clip setting means 14 is arranged between the displacer 7, i.e. between the e.g. two sets of displacer jaws, said clip setting means 14 can set two neighbouring clips 2 and a separator 16, which acts on the casing 4 between said clips 2, can separate said casing 4 between the two clips 2.

The vacuum filler 3 has provided thereon a rotatable part 8 which is adapted to be driven by a servomotor 9. The rotatable part 8 has arranged thereon a shaft 6 which is, in turn, connected to a rotatable part 5 of the clip module 1. By means of said rotatable part 5 of the clip module 1, at least some of the various components of the clip module 1 can be driven mechanically. The shaft 6 can be comprised in the clip module 1 or it may only be adapted to be connected to said clip module 1. A horizontal shaft 6 permits a simple structural design, especially if the shaft 6 is to be connected to the servomotor 9, which is also provided for driving a twist-off means, since said twist-off means is often arranged at the side of the vacuum filler 3.

It follows that the vacuum filler 3 comprises an attachment means for the clip module 1 which comprises the mechanical components as well as the components required for control processes. In the case of the present embodiment, the mechanical components of the vacuum filler 3 are e.g. the rotatable part 8, and the control components are the control unit 10, which is configured for controlling a clip module 1.

Downstream of the clip module 1, a suspension unit 12 is shown, which comprises a rail having hooks 15 arranged thereon. The suspension unit 12 can be controlled from the vacuum filler 3 or the clip module 1 via a signal line which is not shown. Also the suspension unit 12 can be driven by the vacuum filler 3, provided that the vacuum filler 3 is provided with a suitable drive means. The hooks 15 can be pivoted into the path of the casing discharged from the clip module 1 so that the casing 4 will be seized by the hooks 15 and suspended. The casing 4 can be suspended selectively after every second portion, as can be seen e.g. in FIG. 1, or after any other number of portions, e.g. 5 or 10.

In the case of the embodiment shown here, the clip module 1 is not provided with an electric or pneumatic drive of its own. Other embodiments can, however, be provided with one or several additional drives, especially for auxiliary functions.

The shaft 6 between the rotatable part 8 of the vacuum filler and the rotatable part 5 of the clip module 1 can be arranged around the stuffing tube 13, or it may also be arranged at the side of or below the stuffing tube 13.

The shaft 6 is adapted to be connected to part 8 or part 5, positively or non-positively, by suitable couplings, such as claw couplings or the like where teeth are provided instead of claws. The parts 5 or 8 may also be coupled to the shaft 6 via respective gears, gear units, belts, toothed belts, etc.. A gear unit can be provided between the servomotor 9 and the clip module 1 at any suitable location. Preferably, a gear unit is arranged on the side of the clip module 1 so that a driving speed predetermined by the vacuum filler 3 can be adapted to the requirements of the clip module 1.

FIG. 2 shows a second embodiment. A vacuum filler 3 comprises two servomotors 9 and 9′. The servomotor 9 is coupled to the rotatable part 8 which is coupled to the shaft 6 and the rotatable part 5 of the clip module 1.

Furthermore, a twist-off unit 11 is provided, which can be driven by a servomotor 9′.

A clip module 1 with a clip setting means 14 is arranged downstream of said twist-off unit 11 and serves to set clips 2 at the locations of the casing 4 at which twisting off has been effected. The clip module 1 can also set the clips 2 directly at the twist-off unit 11.

Just as in FIG. 1, a suspension unit 12 is arranged downstream of the clip module 1 also in the present case. The suspension unit 12 can be controlled or driven by the clip module 1 or the vacuum filler 3.

The servomotors 9 and 9′ are connected to a control unit 10 via suitable lines. The control unit 10 can also be provided for controlling the clip module 1 and/or the suspension unit 12.

Also in this case, the clip module 1 is not provided with an electric or pneumatic drive of its own. The clip module 1 is coupled mechanically to the vacuum filler 3 via the shaft 6.

Both the clip module 1 according to FIG. 1 and the clip module 1 according to FIG. 2 can be provided with means for inserting a thread or a loop when the clips are being set.

The method of applying a clip 2 will be explained in the following with reference to FIG. 1.

The hopper arranged at the top of the vacuum filler 3 is filled with a pasty substance which is conveyed by a conveyor means in the vacuum filler 3 to the stuffing tube 13. At the end of the stuffing tube 13, the pasty substance is discharged into the casing 4′ applied to the stuffing tube 13 so that a casing 4 filled with pasty substance is produced. The casing 4 enters the clip module 1 in which a displacer 7 is arranged by means of which a constriction of the casing is produced. At the location of said constriction, a clip 2 can be set by a clip setting means 14. It is also possible to set two clips side by side, so that the sausages produced can be separated between two neighbouring clips 2 later on. The sausages discharged from the clip module 1 are seized by the hooks 15 of the suspension unit 12 so that they can hang down from the hooks 15. The separator 16 can also carry out a separation after a specific number of portions so as to produce a singulated string comprising a specific number of portions.

The displacer 7 and the clip setting means 14 as well as the optional separator 16 of the clip module 1 are mechanically driven by the rotating part 5 of the clip module 1 which is, in turn, driven by the servomotor 9 of the vacuum filler 3 via the shaft 6 and the rotatable part 8.

1. An apparatus comprising:
a vacuum filler (3) for stuffing a casing (4) of any kind with a pasty substance and a clip module (1) for applying a clip (2) to a stuffed casing (4), characterized in that the clip module (1) is adapted to be driven by the vacuum filler (3).

2. An apparatus according to claim 1, characterized in that the clip module (1) comprises a part (5) which is adapted to be rotatably driven by the vacuum filler (3).

3. An apparatus according to one of the claim 1 or 2, characterized in that the vacuum filler comprises a part (8) which is adapted to be rotatably driven and by means of which the clip module (1) can be driven.

4. An apparatus according to one of the claims 1 to 3, characterized in that the clip module (1) and the vacuum filler (3) have arranged between them a shaft (6), which is connected to the vacuum filler (3) for driving the clip module (1), said shaft (6) being preferably a horizontally extending shaft.

5. An apparatus according to one of the claims 1 to 4, characterized in that the clip module (1) comprise a displacer (7).

6. An apparatus according to one of the claims 1 to 5, characterized in that means are provided for inserting a thread or a loop when the clips are being set.

7. An apparatus according to one of the claims 1 to 6, characterized in that a separator (16) is provided for separating respective portions.

8. An apparatus according to one of the claims 1 to 7, characterized in that a servomotor (9) of the vacuum filler (3) can be used for driving the clip module (1), said servomotor (9) being preferably adapted to be used for driving also other functions, such a the twisting off.

9. An apparatus according to one of the claims 1 to 8, characterized in that a control unit (10) is provided for controlling the stuffing, the portioning and the clipping and, preferably, also the separating and the suspending.

10. An apparatus according to one of the claims 1 to 9, characterized in that a twist-off unit (11) is provided adjacent to a stuffing means of the vacuum filler (3).

11. An apparatus according to one of the claims 1 to 10, characterized in that a preferably automatic suspension unit (12) for selectively suspending the casing (4) is provided, said suspension unit (12) being controlled and/or driven preferably by the vacuum filler (3) and/or the clip module (1).

12. A method of applying to a casing (4) of any kind a clip (2) by means of a clip module (1), said method comprising the steps of:
stuffing the casing (4) with a pasty substance by means of a vacuum filler (3), separating the portions, applying a clip (2) by means of a clip module (1), characterized in that the clip module (1) is driven by the vacuum filler (3).

13. A method according to claim 12, characterized in that the portions are separated from one another.

14. A method according to claim 12 or 13, characterized in that the separation and the setting of clips take place, at least partly, at the same time.

15. A method according to one of the claims 12 to 14, characterized in that the casing (4) is suspended automatically when the clips have been set.

16. A method according to one of the claims 12 to 15, characterized in that a thread or a loop is attached, preferably when the clip (2) is being set.
